(19) United States
(12) Patent Application Publication
(10) Pub. No.: US 2003/0125980 A1
(43) Pub. Date: Jul. 3, 2003

(54) Process and system for verifying the maintenance condition

(76) Inventor: Jose Guilherme Whitaker Ribeiro, Barueri (BR)

Correspondence Address: ELMAN TECHNOLOGY LAW, P.C., P O BOX 209, SWARTHMORE, PA, 19081-0209, US

(21) Appl. No.: 10/324,676

(22) Filed: Dec. 20, 2002

(30) Foreign Application Priority Data
Dec. 21, 2001 (BR) 0106600

(51) Int. Cl. G06F 17/60

(52) U.S. Cl. 705/1

(57) ABSTRACT

The invention refers to a innovator process and system for verifying the maintenance condition of used goods, based on QFD—Quality Function Deployment and WBS Work Breakdown Structure techniques, which produces understandable reports specially designed and intended to furnish information to users and potential buyers, who do not need to be technicians in the area relative to the specific good.

In the present invention, these methodologies are applied in the innovating verification and analysis process of the condition of used goods, such as vehicles, machines, properties, etc.

### FIELD OF THE INVENTION

The present invention refers to a man-machine application, based on advanced correlation techniques, of an innovating computational process and system related to evaluation of goods.

More specifically, the invention object of this Descriptive Report is comprised by a new process and a new system for verifying the maintenance condition of used goods, based on the QFD (Quality Function Deployment) and WBS (Work Breakdown Structure) techniques, applied on a used good and the production of understandable reports, specially designed and intended to offer information to users and potential buyers, who do not need to be technicians in the area relative to the good in question.

Thus, the invention object of this Descriptive Report, so called PROCESS AND SYSTEM OF VERIFYING THE MAINTENANCE CONDITION, refers to a computerised system that uses concepts from the methodology called “Quality Function Deployment”, also known by the initials QFD and of the Work Breakdown Structure of a good methodology, known by its initials WBS.

In the present invention, these methodologies are applied in the innovating verifying and analysis process of the condition in which used goods are, such as vehicles, machines, properties, etc.

### STATE OF ART

In the marketing of used goods, the concern to know the actual maintenance condition, as a key factor in the purchase decision, always was a limiting problem for developing this activity.

The potential buyer, nearly always, needs relevant, reliable and ordered information on the condition of the good that he wants, to properly evaluate the advantages and disadvantages of the intended purchase, comparing the benefits with those of the available alternatives.

Such information can be obtained by the buyer himself, as well as through people who deserve his trust.

Nowadays, what exists in relation to information on the maintenance condition are some types of very deficient reports that, really, are incomplete due to the narrow range or to the subjectivity of the evaluation and do not hermetic, language intended for technical groups of juridical persons and that, in general, compare the present performance of the good with that proclaimed about a new good.

Other examples are reports made by assessment companies, in which the focus is the market value. In those types of reports, the description of the maintenance condition, when it exists, is brief and offered as complementary information.

There is also the case of the reports made by companies specialised in real state, intended for insurances and financing. Those, generally, have a small range, hermetic language and very little use for the buyer.

And there is also the case of reports regarding vehicles in the mandatory verifying situations, when the objective is to meet an specific legislation for the licensing of vehicles of a certain age (in particular countries and regarding the safety and pollution items).

At preset, there are no reports on the maintenance condition of used goods that could meet the actual information requirement of most of the buyers, so that they would have a clear view of the advantages and disadvantages of the business in question, except for some special individual reports made to order generally fit into the basic informative objective to which the invention herein proposed refers.

Some of these types of reports, for example, those written by salesmen, or by they agents, are characterised for the lack of exemption of the information they contain.

Other examples are those produced in a casuistic and circumstantial manner, not standardised, as is the case of technical reports written by experts to elucidate juridical disputes; as is the case of the reports written in the format of budgets for repairs by companies that carry out such repairs, which also are not exempt and only cover the defects in question; and as is the case of the reports intended for a guarantor of the good (insurance companies or institutional salesmen), and not for the buyer, which are characterised by the lack of objectivity in the information.

Some reports are also known that, although they are trivial, are incomplete regarding the basic scope of informing a potential buyer on the actual maintenance condition of a good.

They are also reports written by inspection engineering companies, like those of the “Societe General de Surveillance (SGS)”, generally relative to complex equipment, produced in a highly technical, and even by a buyer, with the specific characteristics of a certain business.

And that fact is explained by the non-existence, until then, of a process, now prepared, object of the present invention and of a computerised system for its implementation, which uses the concepts of the methodology so-called Quality Function Deployment—QFD and of the methodology of Work Breakdown Structure—WBS—of a good.

Below are the general objectives of the present invention.

### OBJECTIVES OF THE INVENTION

One first objective of the present invention is to establish a computerized process and system, based on QFD techniques, capable of generating complete and understandable reports, even for persons who do not have great specific technical knowledge and that inform the actual condition of the good analysed, indicating its irregularities, a cost estimative and the urgency of the repairs.

The second objective of the present invention is to establish a computerized process and system, based on QFD techniques, capable of generating reports that allow the knowledge the actual condition of a good, without the need of the interested party examining it physically or have the technical knowledge to do so.

And the third objective of the present invention is to establish a computerized process and system, based on QFD techniques, capable of generating reports prepared from standardised concepts (which minimizes the possibility of the checking agents using their personal opinion as a decisive factor of the evaluation).

### GENERAL DESCRIPTION OF THE INVENTION

The invention object of this Descriptive Report comprises a new and original system, including an innovating process of verifying the maintenance condition of used goods, based on advanced QFD (Quality Function Deployment) and WBS (Work Breakdown Structure) techniques, applied to a used good, which produces understandable reports, specially designed and intended to offer information to potential buyers, not necessarily experts in the area relative to the good.

The reports produced by the PROCESS AND SYSTEM OF VERIFYING THE MAINTENANCE CONDITION, object of the present invention, are intended for various publics, such as companies that intend to purchase Used goods and wish to have a wider knowledge of their working condition and wear and tear, as well as a pre-budget of the essential expenses for immediate or future repairs. Companies that wish to sell a certain good and want to offer exempt reports, which describe exactly the corresponding maintenance condition, are also included.

It is also the case of companies that need to know, in detail, the actual situation of their tangible assets, specially equipment and buildings, as well as obtaining an approximate evaluation of the expenses relative to the necessary repairs, including for corporative reorganization, merger or purchase purposes.

It is also the case of private individuals who intend to negotiate used goods (mainly vehicles or residential or commercial properties) and need to know and offer more data on their maintenance condition and the necessary expenses to leave them in perfect order.

It also would be the case of a private or corporative buyer who is not able to have a direct contact with the good to be purchased, either due to the geographical distance or lack of time or for any other reason, such as what occurs with the purchases via Internet.

Apart from those aspects, the spatial dimension must be taken into account. The business of many companies and institutions is local and, as a result, they need to expand the area they cover and establish physical presence in different districts or regions of the country (and even abroad).

Nowadays, when such types of services need to be rendered in other districts, normally it is necessary to displace checking agents up to the location, which, obviously, increases a great deal the costs of each inspection.

In addition, there are opportunities to be seized, not only in Brazil, but also abroad (due to the existence of the Mercosul, ALCA, EU, etc.), there also are threats to be faced, such as the possibility of the entry, in the market, of large competitors international (or substitutes).

Thus, the invention object of this Descriptive Report is comprised by a new and original system, including an innovating maintenance condition verifying method of used goods, based on advanced QFD (Quality Function Deployment) and WBS (Work Breakdown Structure) techniques applied on a used good, which produce of understandable reports, specially designed and intended to offer information to potential buyers, who do not need to be technicians in the area relative to the good in question.

In order to attain this scope, the final product of the process application, using the corresponding system, will produce reports that obey the following basic characteristics:

a) Regarding their preparation, they are characterized by a drastic reduction (or elimination) of the subjectivity inherent to the assessor's point of view.

b) Regarding their contents, they are characterized by the extent and objectivity of the information.

c) And, regarding their presentation, by the standardization of form and contents, making it easy for the common user to understand.

To better understand the PROCESS AND SYSTEM FOR VERIFYING THE MAINTENANCE CONDITION, object of the present invention, eight drawings, attached at the end of this document, are described bellow.

### BRIEF DESCRIPTION OF THE DRAWINGS

FIG. 1 illustrates the system's general block diagram, showing its main components, according to a preferred embodiment of the present invention;

FIG. 2 shows the main steps involved in establishing the Table of the Hierarchized Qualities (18), according to an embodiment of the present invention;

FIG. 3 shows the activities involved in the Classification of the Qualities (27).

FIG. 4A schematically shows the establishing of the Quality Matrix, by creating the establishing the correlations (31) to define the hierarchy relative to the classification (32) (weight relative to each item to be verified). The horizontal arrow represents a multiplication operation of the relative importance level (18) of each quality by the correlation grade. The vertical arrow represents an addition operation of the several products described above in order to obtain the classification hierarchy (32), according to a preferred embodiment of the present invention.

FIG. 4B is a diagram of the process to obtain weighted evaluation grades (35). The horizontal arrow represents a multiplication operation of each of the classification relative importance levels (22) by the respective grade assigned by the assessor (34) for that measure (verifying item).

FIG. 5 illustrates the correlation matrix of each of the weighted evaluation grades (38) of the items with the several items of the good's work breakdown structure (36). The composition of the various grades of items belonging to a certain system of the good will allow to establish an indirect evaluation of the various systems (40) and of the good itself.

FIG. 6 illustrates the main phases (41 up to 45) previously involved in the execution of the preliminary inspections.

FIG. 7 illustrates the basic phases (46), (47) and (51) and the adjustments (48 up to 50) possible to be performed in order to obtain a Standardized Procedure (52).

FIG. 8 schematically illustrates the integration of the process and system to verify the maintenance condition, object of the present invention, according to one of its embodiments.

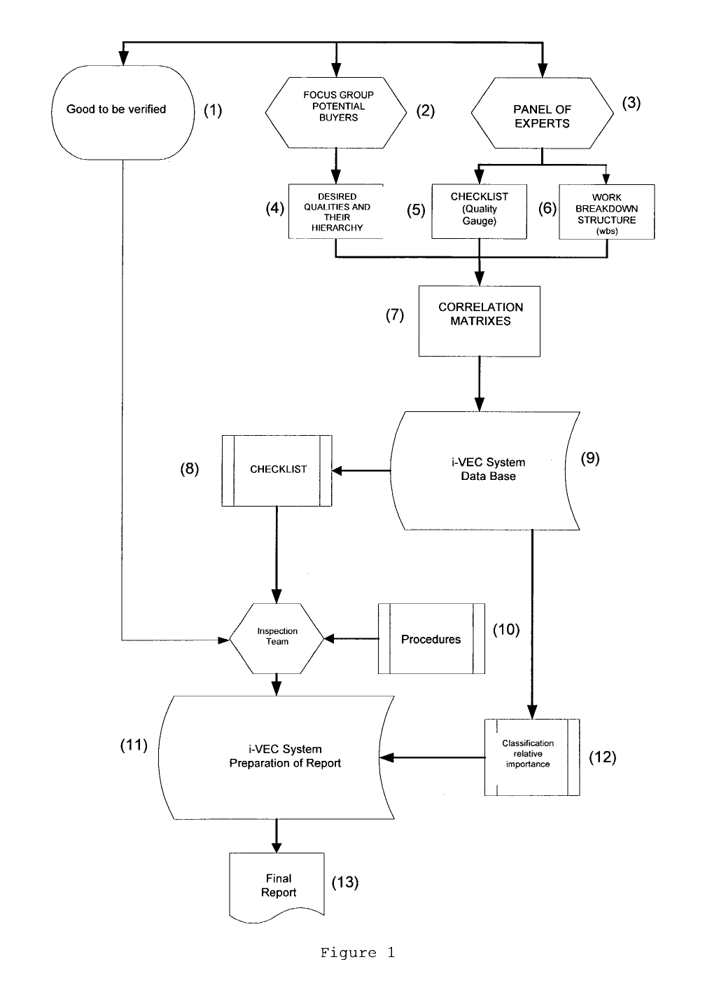

Based on the above mentioned drawings, below there is a description of the preferred embodiment of the present invention.

### PREFERRED EMBODIMENT OF THE INVENTION

The present invention is comprised by integrated computerised process and system.

The process is based on QFD and WBS techniques, comprising eight steps described below, which use standardised verifying procedures, hierarchized, quality gauges, work breakdown structure of the goods being evaluated, checklists, correlation matrixes, in order to produce reports in which the subjectivity of the evaluations is eliminated, keeping the hierarchy of the quality desired.

At the end, grades indicating the maintenance condition of each component system of the good are obtained and, based on these, its overall evaluation grade.

The computerised system that serves as a support for the application of the process, briefly described above, is composed, basically, of a database and a result weighing and report issuing software.

To produce the reports, object of the PROCESS AND SYSTEM FOR VERIFYING THE MAINTENANCE CONDITION, the eight step process, described below, is used:

Step 1. Analysis of the good's category

Step 2. Establishing the “Table of Hierarchized Qualities”

Step 3. Defining the items or functions to be verified (Quality Gauge)

Step 4. Assembling the Correlation Matrix

Step 5. Establishing the Evaluation Grades

Step 6. Establishing the Verifying Preliminary Procedures

Step 7. Adjustments for establishing the Verifying Standardised Procedure

Step 8. Establishing the interfaces with the Database and with the Result Weighing and Report Issuing software.

Below are the details of the steps of the maintenance condition verifying process of used goods, object of the invention.

Step 1. Analysis of the Good's Category

The good to be inspected (1) is analysed from the point of view of the perspective of repetitive similar inspections.

If they are frequently repeated, a Standardised Verifying Procedure will be initiated. On the contrary, the inspection will be performed directly by the experts, without the concern of previously creating a standardised procedure group (10).

Step 2. Establishing the Table of Hierarchized Qualities

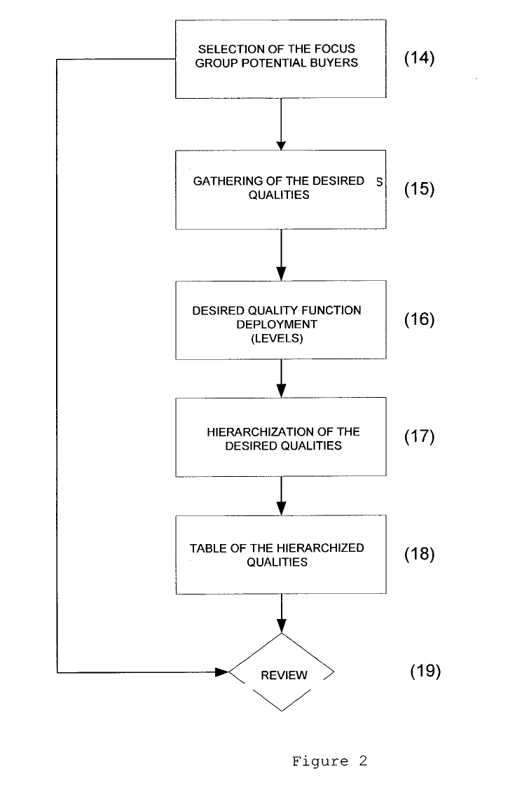

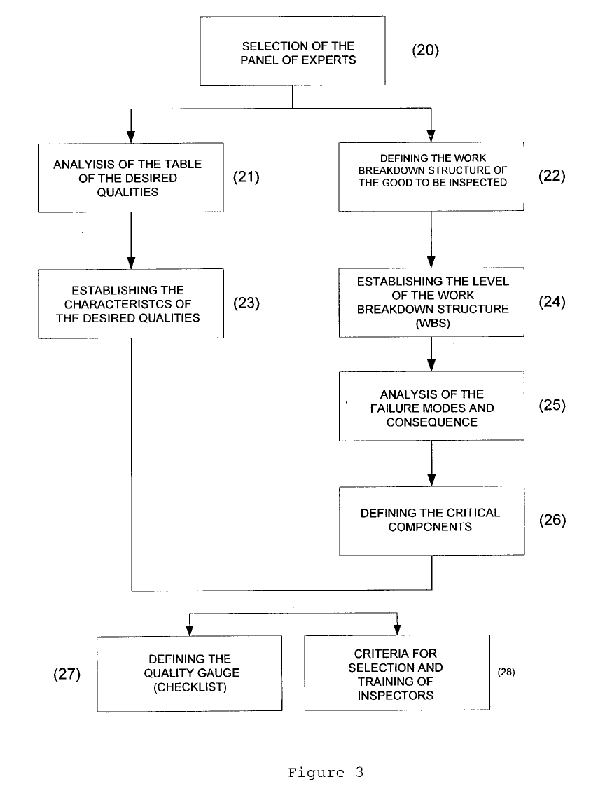

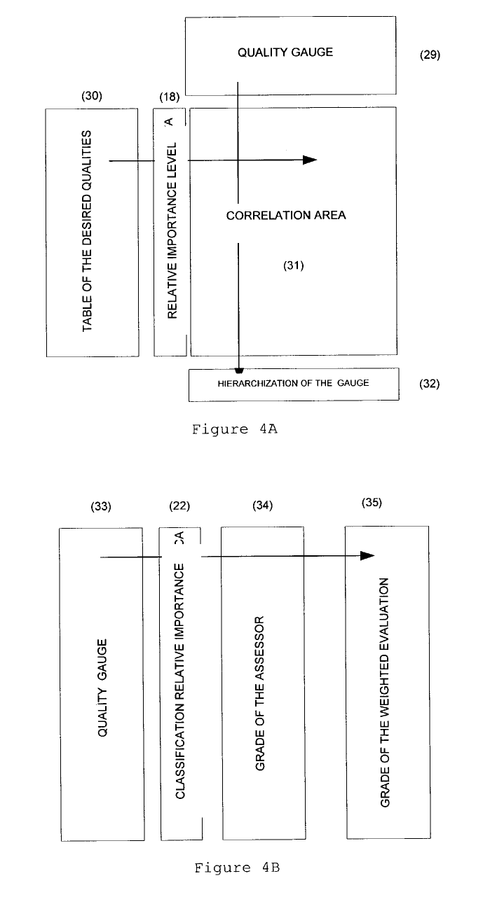

FIG. 2 schematically illustrates this step.

Once the category of the good to be verified has been defined and analysed, the public (14) with the largest potential to become buyers of that type of good and, consequently, buyers of the services object of the invention, must be defined.

Surveys must be made with this previously defined public to know which are the desired characteristics or qualities (15) considered more relevant and important by the potential buyers of the good.

The surveys must also establish how the desired qualities (15), for the good being offered, must be presented to the potential buyers. The surveys are conducted by people with wide understanding of this type of good, according to the methodologies used in market surveys.

In addition, within the recommended methodology in the QFD, the characteristics or qualities, desired by the potential buyers, are broken down (16) beginning at the first level (most vague) and passing through the successive levels, thus making the desired characteristics clearer and more specific.

As well as breaking down the desired characteristics, in this step the importance degree relative to each one of the characteristics is also defined, thus, establishing their relative hierarchy (17).

Once hierarchized, the qualities must be consolidated in a table (18), so that they are immediately visible and understandable.

The final step is comprised by a review (19) of the process until then carried out, where a “fine adjustment” and a step consolidation will be made.

At the end of this step, which is important for the potential buyers of the good and which is the relative importance of each one of the desired qualities will be established.

Step 3. Defining the Items or Functions to be Verified (Quality Gauge)

The verifying of the quality characteristics of a good can only be carried out with the necessary objectivity if done from a checklist (8) based on the work breakdown structure (6) of the good being evaluated.

Therefore, for the checklist to be useful to the potential buyer of the good, must have a narrow correlation with the desired qualities (4), thus becoming a “gauge of the desired qualities” (27).

The establishing of the Quality Gauge is preformed by a panel of experts (3 and 20) with a large knowledge and experience relative to the type of good to be evaluated.

This panel of experts will be responsible for analysing the Table of Hierarchized Qualities (21), prepared in the previous step, and by establishing the characteristics (functionality, composition, etc.) of these qualities (23), thus forming the base for a later final definition on the gauge of these qualities (27).

In this step, the work breakdown structure of the good to be inspected (22) also is defined, and, based on this definition, the structure breakdown level (24) is established.

Once established the WBS, an analysis of fault modes (25), of the good being analysed, and of the consequences of those faults will be carried out, in order to obtain the qualities desired by the potential buyers.

Through the analysis of faults and consequences (25), it will be possible to establish the critical components (26) of the type of good being analysed that, jointly with the quality characteristics (23) already established, form the base for the final definition of the items or functions to be verified, making up a checklist to be used as a quality gauge (27).

Step 4. Assembling the Correlation Matrix

In step 2 the qualities desired (4) and their relative importance degree were gathered from the potential buyers of the good.

In the previous step, a gauge was established, i.e., a way to measure the desired qualities.

These several measurements, however, do not necessarily have the same relative importance to obtain the quality desired for the good.

Assembling the so-called “Quality Matrix” will perform the transfer of the quality relative hierarchy to the quality gauge, according to the QFD methodology.

The transfer process will be carried out by the correlations (31) placed in the body of the matrix, between each one of the desired qualities (30) (Table of the Hierarchized Qualities) and the various quality measurements (quality gauge) (29).

The correlations are made by assigning correlation levels (18) (strong, average, weak or non-existent) and numerical values convenient for these levels.

Based on this correlation, it is possible to establish the gauge hierarchization (32), i.e., the relative weight to be assigned to the items or functions of the type of good, previously established.

Thus, this step of the process allows the transfer to the gauge the relative importance of each of the qualities desired by the potential buyers of the goods, making it possible for the assessors to measure the quality of the good with the same scale used by the potential buyers when they subjectively assess the good.

Therefore, by means of this process, the subjectivity of the evaluation is removed, keeping the hierarchy of the qualities desired by the possible buyers.

The quality gauge (33), and their hierarchization, will be the key element to prepare the checklist and the procedure to be used by the assessors during the verifications.

Step 5. Establishing the Evaluation Grades

The evaluation grades of the good verified (35) are established based on the assessors' grades (34) for each of the items of the checklist. The grades assigned to each of the items of the checklist may be numerical or non-numerical (good, average, bad).

The grade assigned by the assessor is, in a later processing, weighted by the relative importance level of the corresponding measure (22), thus, obtaining weighted evaluation grades (35).

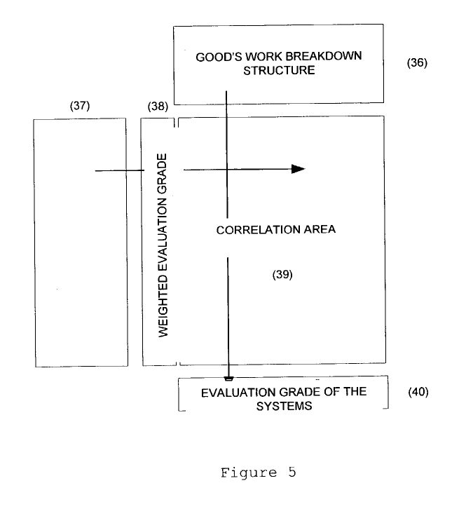

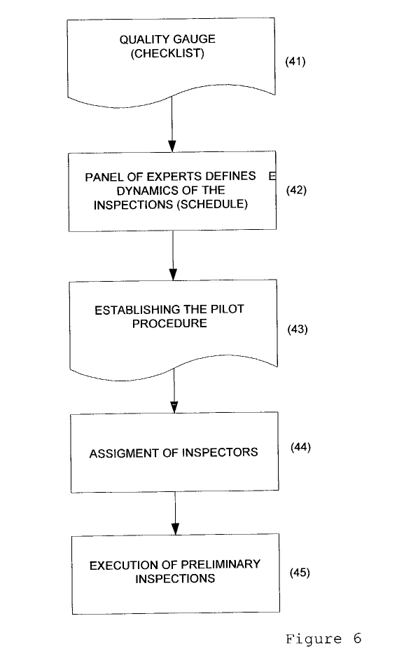

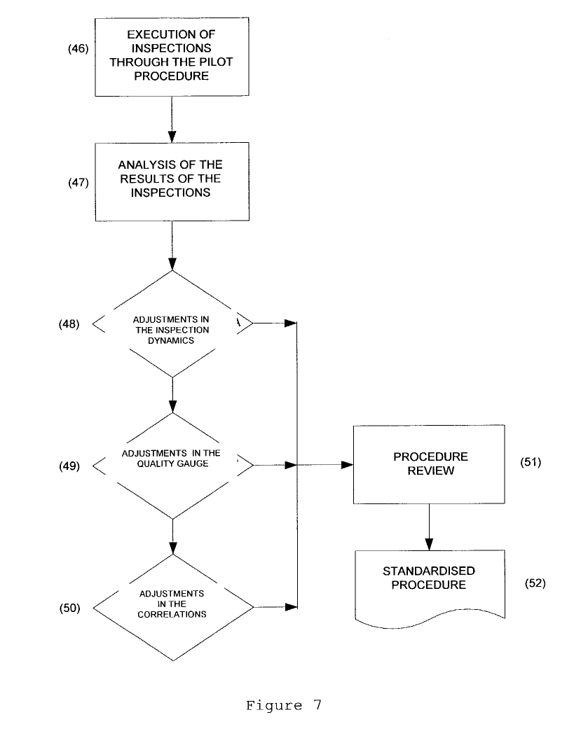

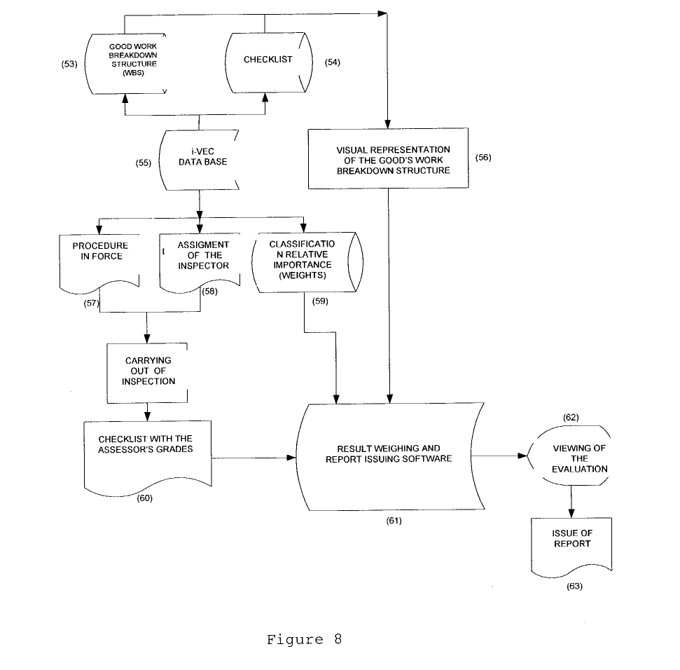

As FIG. 5 shows, by means of a second correlation process (39), now between the gauge (37) (checklist items), with their relative importance, and the work breakdown structure (36) of the good, the evaluation grades (40) of the several component systems of the good (or functions of the systems) can be obtained.

Through this procedure it is possible to establish a grade that indicates the maintenance condition of each one of the systems that compose the good and, based on these, the overall evaluation grade of the good in question.

In this way, it will be possible to establish, in a very objective manner, the repair cost of the good being verified.

Step 6. Establishing a Verifying Pilot Procedure

The good's verifying pilot or preliminary procedure is established based on the checklist (8) previously obtained.

From this list, the panel of experts (42) established a pilot procedure (43) for the inspections, showing the most convenient dynamics for the good's inspection.

The pilot procedure is tested during a convenient number of inspections.

The purpose of the initial verifications is to crosscheck the dynamics of the verifications and the adjustment of the procedure.

The results obtained in the initial verifications are processed applying the weights established by the gauge hierarchization, in order to obtain the final values of the maintenance condition of the good being verified.

Step 7. Adjustment of the Model and Establishing the Standardised Verifying Procedure

Once the final values of the maintenance condition are obtained, they may or may not be coherent with the estimate obtained by the panel of experts, during the preparation of the Correlation Matrix and of the Weighted Evaluation Grade.

If necessary, adjustments will be made in the dynamics of the inspection (49) and in the quality gauges 49), resulting in new correlations (50) and in the review of the Inspection Procedure (51).

At the end, the verifying schedule and all the methods described in steps number 2 to 6 must be standardized (52).

Step 8. Establishing Interfaces with the Database and the Result Weighting and Report Issuing Software.

By applying the WBS and QFD concepts, the functional structure of the good verified and the weights and weighted grades relative to the structure, were respectively established.

Based on these concepts and definitions, a software tool (61) was created, which transforms the language of the verifications, standardizing them so that the users of the system will have access to the final products resulting of each verification, i.e., the verification reports of the maintenance condition of used goods.

The tool consists of a computer software (61) that, based on the results obtained in each verification, transforms them in images and graphic representations, in the format of tables, drawings, simulations, codes, in order that the user will easily understand the analysis carried out in the field by the teams of inspectors.

This software also is responsible for issuing the final reports shown via Internet, or printed on paper or on any other equivalent means, to be developed in the future, by the company that renders those services.

The system's database (55) is directly linked to this software (61), supplying it with informative standards of tables and fields to be filled in.

The data of each verification are entered in the software, which calculates the maintenance condition grades of the functional groups and of the good verified, in a general way.

When a good must be verified, it is registered in the system's database and, if the database recognises this type of good, a team is assigned (44), responsible to execute this verification (45); if the database informs that it is the first time that this type of good is verified, the procedure and the checklist are provided, according to the previous steps, in order to allow this object to be verified.

The team must have the specific qualifications to correctly verify the good in question, if such team does not exist, a team of experts must be assigned to follow the execution of the service.

The team goes where the good is and, according to the standardized procedures and to the checklist prepared for that type of verification, the object is inspected, until all items have been verified.

The data is later sent to the system, so that it can prepare and issue a report on the object verified, i.e., where there are ready models and established procedures for this type of object.

If there is a model ready and established procedures to issue the report (i.e., a preestablished layout), a report for that object is produced.

On the other hand, a team of experts is assigned to establish the standard of the report and prepare the necessary procedures.

Finally, a report is delivered to the client (user) who made the order.

1) process for verifying the maintenance condition, applied on used goods, characterised by comprising the following steps:
Analysis of the Good's Category
Establishing the Table of Hierarchized Qualities
Defining the Quality Gauge
Assembling the Correlation Matrix
Establishing the Evaluation Grades
Establishing the Verifying Preliminary Procedures
Adjustments for Establishing the Verifying Standardized Procedure
Establishing Interfaces with the Database and the Result Weighing and Report Issuing Software.

2) PROCESS FOR VERIFYING THE MAINTENANCE CONDITION, applied on used goods, according to claim 1, characterised by, in the step of analysis of the good's category, it being initially verified and analysed from the point of view of the perspective of repetitive similar inspections.

3) PROCESS FOR VERIFYING THE MAINTENANCE CONDITION, applied on used goods, according to claim 2, characterised by comprising a verifying standardised procedure, when the repetition is frequent.

4) PROCESS FOR VERIFYING THE MAINTENANCE CONDITION, applied on used goods, according to claim 1, characterised by the step of Establishing the Table of Hierarchized Qualities comprising:
surveys to gather the characteristics and qualities desired made with a previously defined public
defining the presentation of qualities desired for the good being offered
deploying the characteristics or qualities from the first level to the successive ones
defining the relative hierarchy, from relative importance degree of each one of the characteristics
consolidating the qualities in a table so that they are immediately visible and understandable
process review.

5) PROCESS FOR VERIFYING THE MAINTENANCE CONDITION, applied on used goods, according to claim 1, characterised by the step of Quality Gauge comprising:
analysing the table of hierarchized qualities
defining the work breakdown structure of the good
establishing the structure breakdown level
analysing the good's failure modes and consequences
defining the good's type critical components
final definition of the checklist to be used as quality gauge.

6) PROCESS FOR VERIFYING THE MAINTENANCE CONDITION, applied on used goods, according to claim 1, characterised by the step Assembling the Correlation Matrix comprising:
assembling the Quality Matrix
placing the correlations between each one of the desired qualities and the various quality measurements (quality gauge) in the matrix body
assigning the correlation levels (strong, average, weak or non-existent) and the convenient numerical values to these levels
establishing the gauge hierarchization.

7) PROCESS FOR VERIFYING THE MAINTENANCE CONDITION, applied on used goods, according to claim 1, characterised by the step of Establishing the Evaluation Grades comprising:
weighing the assigned grade, by means of the relative importance level of the respective measure
obtaining, in a second process of correlation between the gauge (checklist items) and the work breakdown structure, of the evaluation grades from the various component systems of the good (or system functions)
establishing the indicative grade of the maintenance condition of each one of the systems that compose the good and, based on these, the overall evaluation grade of the good in question
establishing the repair cost of the good being verified.

8) PROCESS FOR VERIFYING THE MAINTENANCE CONDITION, applied on used goods, according to claim 1, characterised by the step of Establishing a Verifying Pilot Procedure comprising:
establishing a pilot procedure for the inspections that reflect the most convenient dynamics for the good's inspection
testing the pilot procedure
processing the results obtained in the initial verifications, applying the weights defined by the gauge hierarchization
obtaining the final values of the maintenance condition of the good verified.

9) PROCESS FOR VERIFYING THE MAINTENANCE CONDITION, applied on used goods, according to claim 1, characterised by the step of Adjusting the Model and Establishing the Verification Standardised Procedure comprising:
adjusting the dynamics of the inspection and the gauges of the qualities, resulting in new correlations and review of the Inspection Procedure
standardising the verifying schedule and all the methods described in steps 2 to 6.

10) PROCESS FOR VERIFYING THE MAINTENANCE CONDITION, applied on used goods, according to claim 1, characterised by the step of Establishing Interfaces with a the Database and the of Result Weighing and Report Issuing Software comprising:
transforming the results of each verification into images and graphic representations in the format of tables, drawings, simulation and codes understandable to the user
presenting the final reports via Internet, or printed on paper or on any other equivalent means
feeding the database with informative standards of tables and fields to be filled in.
calculating the grades of the maintenance condition of the functional groups and the good verified.

11) PROCESS FOR VERIFYING THE MAINTENANCE CONDITION, applied on used goods, according to claim 1, characterised by comprising:
software for transforming the results of the verifications into images and graphic representations on the format of tables, drawings, simulations and codes understandable to the user.
software for issuing the final reports presented via Internet, or printed on paper or on any other equivalent means.
database linked directly to this software that feeds it with table informative standards and fields to be filled in.
verification database, which enters them in the software that calculates the maintenance condition grades of the functional groups and the good verified.
